(19) United States
(12) Patent Application Publication
(10) Pub. No.: US 2007/0248501 A1
(43) Pub. Date: Oct. 25, 2007

(54) SPECIMEN HANDLING DEVICE

(75) Inventors: Glen Morgan, Renton, WA (US); Robert L. Clark, Bellevue, WA (US)

Correspondence Address: SEED INTELLECTUAL PROPERTY LAW GROUP PLLC, 701 FIFTH AVE, SUITE 5400, SEATTLE, WA, 98104, US

(73) Assignee: BLUE BAND, L.L.C., Newcastle, WA (US)

(21) Appl. No.: 11/687,994

(22) Filed: Mar. 19, 2007

Related U.S. Application Data
(60) Provisional application No. 60/743,545, filed on Mar. 17, 2006.

(51) Int. Cl. B01L 9/00

(52) U.S. Cl. 422/104

(57) ABSTRACT

A specimen handling device includes a body interposed between a first receptacle configured to removably secure a specimen container and a second receptacle configured to removably secure a medical device. The specimen handling device may further include auxiliary structure for removably securing the specimen container and/or the medical device to the first and/or the second receptacle, respectively. Accordingly, the specimen handling device allows a user to manipulate the specimen handling device with one hand.

### BACKGROUND OF THE INVENTION

1. Field of the Invention

The present invention generally relates to support mechanisms for medical devices, and, more particularly, to a device for securing a medical device to a specimen-collecting device.

2. Description of the Related Art

Conventionally, collecting specimens from patients has involved manipulating a medical device, such as an endoscope that is attached to a container with a plastic tube. FIG. 1 depicts a typical apparatus for collecting a specimen. As illustrated in FIG. 1, existing apparatus 10 includes a tube 12 that transfers a specimen from an endoscope 14 to a container 16. The tube 12 is generally the only means by which the endoscope 14 couples to the container 16. It is typically preferred that a user manipulate the apparatus 10 with one hand in order to have sufficient visibility of the area from which the specimen is extracted. However, the weight of the container 16 causes the flexible tube 12 to shift and/or bend, making it difficult or inconvenient to manipulate the endoscope 14. Movement of the tube 12 may also expose the specimen to risk of loss into the suction line. For example, excessive shifting of the tube 12 may separate the tube 12 from the container 16, especially if the tube 12 repetitively contacts other objects or the patient's body; or excessive rotation of the container 16 can cause a specimen therein to be inadvertently discharged from the container.

Furthermore, as shown in FIG. 1, the user typically has to secure the container 16 with one hand and manipulate the endoscope 14 with the other hand to prevent the container 16 from moving with respect to the tube 12 and/or the endoscope 14. Furthermore, when placed on a surface, the container 16 can inadvertently be situated such that the specimen flows back into the suction tube, and potentially back into the endoscope. Since the user, such as a physician, is typically operating under exigent circumstances, the user may not have the time to exercise sufficient care in positioning the container 16 on a surface to prevent losing the specimen or a quantity of the specimen, which may be maintained if the specimen remains in the container. Even if the user spends the time to gently place the apparatus 10 on the surface, this is not efficient use of the user's time considering it could be spent on other tasks, such as tending to patients.

As collecting specimens may involve entering through an incision, the unstable tube 12 with the container 16 hanging and swinging at one end of the tube 12, may also pose an infection risk if it contacts the patient's body proximate the incision. Furthermore, owing to the disposable nature of the tube 12 and the container 16, and the desired maneuverability of the endoscope 14, any components making up the apparatus 10 need to be lightweight and inexpensive. Therefore, conventionally, the tube 12 and the container 16 are generally fabricated from materials that are weak and may be susceptible to instability and spillage when exposed to excessive movement.

It can be appreciated that collecting specimens from patients, especially internally, is unpleasant and uncomfortable for both the physician and the patient. Therefore, in addition to time and money wasted when a specimen has to be collected more than once, the patient suffers the discomfort of experiencing the collection process again.

In addition, some specimen collection procedures may be time-consuming and require the user's concentration. Accordingly, when a user is required to maintain both of his hands in a position close to each other while trying to manipulate the apparatus 10, such as the position shown in FIG. 1, for a prolonged duration, it is likely that hand pain or other hand or arm issues such as carpal tunnel may be induced due to the un-ergonomic holding position shown in FIG. 1.

Accordingly, there is a need for a handling device that is lightweight and inexpensive, and firmly secures a specimen container to a medical device allowing a user to manipulate the handling device with one hand.

### BRIEF SUMMARY OF THE INVENTION

According to one embodiment, a handling device comprises a first receptacle configured to removably secure a container, a second receptacle configured to removably secure a medical device, and a body interposed between the first and the second receptacles and configured to allow a user to manually manipulate the handling device with one hand.

According to another embodiment, a specimen handling device comprises an elongated body having a first end and a second end, a first receptacle coupled to the first end of the elongated body and having a first arm and a second arm, the first and the second arm forming a cylindrical surface configured to removably engage a specimen container, a second receptacle coupled to the second end of the elongated body and having a first arm and a second arm, the first and the second arm forming a second cylindrical surface configured to removably engage a medical device, a flexible strap coupled to the first arm of the second receptacle toward a first end of the flexible strap and having a locking insert toward a second end of the flexible strap, opposed to the first end of the flexible strap, the flexible strap being configured to extend around and contiguous at least a portion of the medical device and the locking insert being positioned such that the locking insert reaches the second arm after the flexible strap extends around and contiguous the portion of the medical device, and a locking structure attached to the second arm of the second receptacle and having a first shoulder and a second shoulder, the first and the second shoulder being configured to engage the locking insert for retaining the second flexible strap around the at least the portion of the medical device.

According to one aspect, the cylindrical surface of the first and/or the second receptacles comprises a tapered portion forming an at least partially frustoconical surface.

According to another aspect, the flexible strap further comprises a plurality of grooves positioned between the locking insert and the second end of the strap, the grooves configured to allow the second end to slide through the locking structure in a first direction and interact with a surface of the second arm adjacent the locking structure to resist against the flexible strap from sliding in a second direction, opposed to the first direction.

### BRIEF DESCRIPTION OF THE SEVERAL VIEWS OF THE DRAWING(S)

FIG. 1 is an image of an endoscope connected to a container according to the prior art.

FIG. 2 is an isometric view of a handling device according to one embodiment of the present invention.

FIG. 3A is a top view of the handling device of FIG. 2 according to one aspect shown in a first state.

FIG. 3B is a top view of the handling device and container of FIG. 3A, coupled to an endoscope handle, shown in a second state.

FIG. 4 is an end view of the handling device of FIG. 2.

FIG. 5 is a side view of the handling device of FIG. 2.

FIG. 6A is a side view of a handling device according to another embodiment of the present invention.

FIG. 6B is a top view of a portion of the handling device of FIG. 6A.

FIG. 7 is a side view of a handling device according to yet another embodiment of the present invention.

FIG. 8 is a side view of a handling device according to still another embodiment of the present invention.

FIG. 9 is a top view of a handling device according to another embodiment of the present invention.

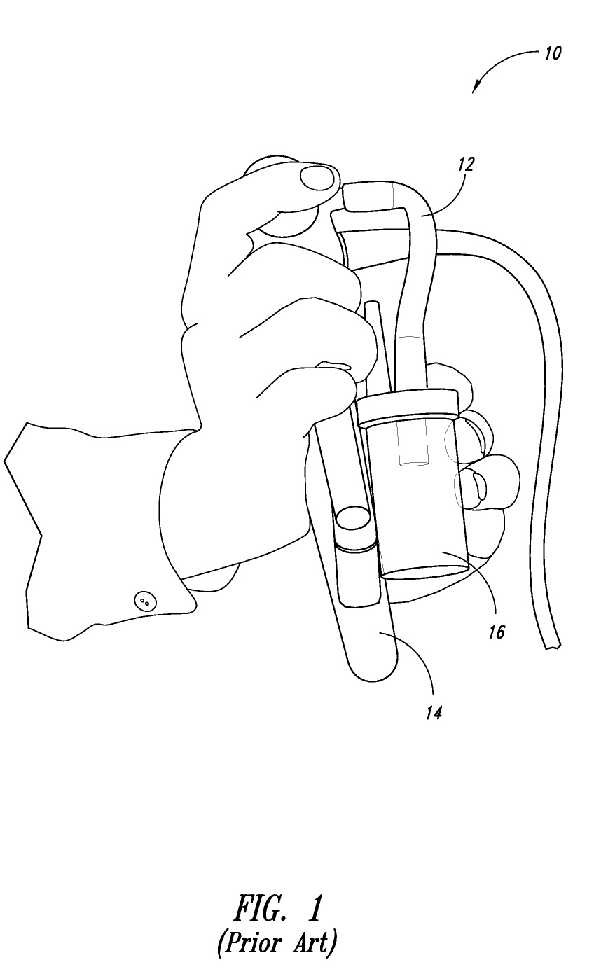

### DETAILED DESCRIPTION OF THE INVENTION

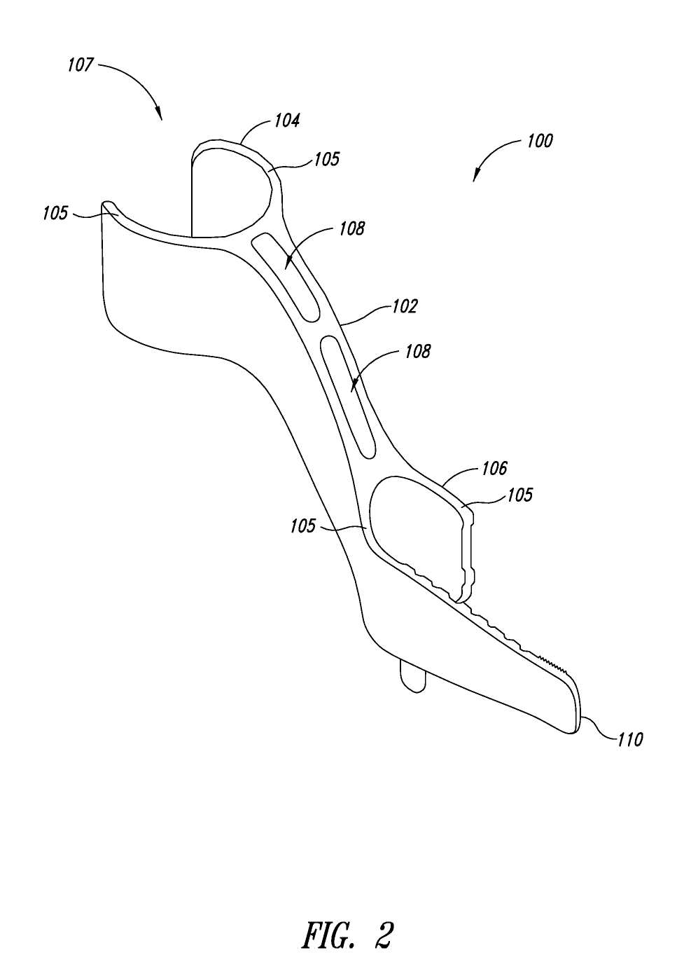

FIG. 2 illustrates a specimen handling device 100 according to one embodiment of the present invention. The specimen handling device 100 comprises a body 102 interposed between a first receptacle 104 and a second receptacle 106. The body 102 may include optional openings 108 for reducing a weight of the device 100. The device 100 can be fabricated from a unitary body of material, for example by injection molding, or it can be fabricated in separate components, such as the body 102 and the first and the second receptacles 104, 106, each including a coupling structure to couple to the body 102. For example, the coupling structure may comprise hook and loop fasteners, adhesives, mechanical fasteners, a locking structure in which the first and the second receptacles 104, 106 may each have a curb securely received in a gutter formed in each end of the body 102, and/or any other suitable coupling means that firmly secures the first and the second receptacles 104, 106 to the body 102.

The body 102, the first receptacle 104, and/or the second receptacle 106 may be fabricated from any suitable material, such as, but not limited to plastics, metals such as aluminum and/or titanium, composites such as carbon-fiber, hard and/or soft woods, ceramics, foams such as STYROFOAM™, glass, silicone, natural and synthetic rubbers and/or any combination thereof, such as a metal frame with a plastic or silicone exterior, and/or any other material suitable to secure a specimen container and a medical device.

In one embodiment, the first receptacle 104 is configured to removably secure a container, for example for collecting a specimen from patients, and the second receptacle 106 is configured to removably secure a device, for example a medical device, which can be in fluid communication with the container, for example via a flexible tube.

In some embodiments, the first and the second receptacles 104, 106 may be resilient to temporarily widen in response to a force and then retract toward their original shape when the force is removed. Therefore, the first and the second receptacles 104, 106 can receive and removably secure the specimen container and the medical device, respectively.

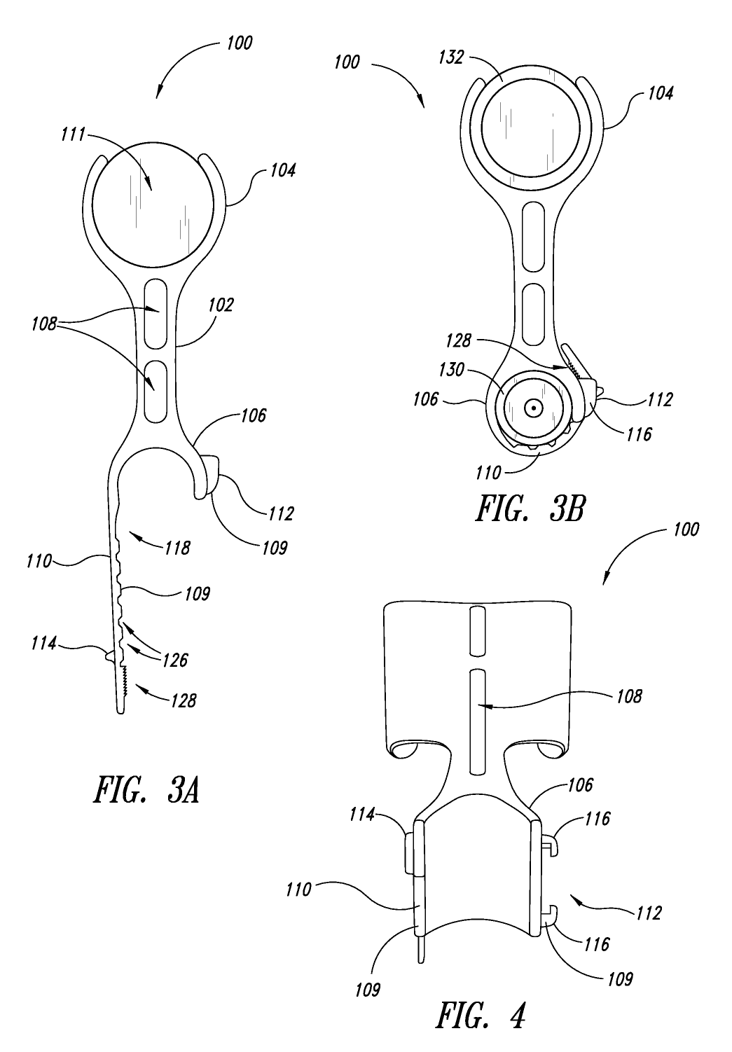

The first and the second receptacles 104, 106 may each comprise arms 105 forming a grip 107. In some embodiments, at least one of the first and the second receptacles 104, 106 may include additional features to securely retain the container and/or the medical device. For example, as shown in FIG. 3A, at least one of the first and the second receptacles 104, 106 may include an optional base 111 against which the container or the medical device can bottom out. In the illustrated embodiment of FIG. 2, the first and the second receptacles 104, 106 are shown to have an arcuate shape; however, other embodiments may include receptacles having other shapes. For example, the first and the second receptacles may include a square, elliptical and/or triangular shape. In other embodiments, a boundary of the first and the second receptacles 104, 106 may not form one particular shape; rather the first and the second receptacles 104, 106 may comprise a malleable material that a user can manipulate to conform a shape of the first and the second receptacles 104, 106 to a shape of a particular medical device and/or container. For example, the first and the second receptacles 104, 106 can be fabricated from a metal strip or a thin metallic part that is formable and surrounded by, or encased or encapsulated in, a flexible plastic and/or silicone. In yet other embodiments, the first and the second receptacles 104, 106 may be rigid and/or include a taper to accommodate containers and/or medical devices with a periphery that is frustoconical.

Accordingly, the first and the second receptacles 104, 106 may be adapted to receive and secure the specimen container and the medical device, such as an endoscope.

In some embodiments, as illustrated in FIGS. 3A and 4, the device 100 may include a securing structure 109. The securing structure 109 may comprise a strap 110 and a locking device 112 attached to the second receptacle 106. The strap 110 is configured and/or sized to extend around and/or at least partially adjacent and/or contiguous the medical device and/or the specimen container, and removably engage the locking device 112. As illustrated in FIG. 3A, the strap 110 may include at least one locking insert 114 that engages the locking device 112. As illustrated in FIG. 4, the locking device 112 includes shoulders 116 that are configured to removably engage the locking insert 114. In operation, the medical device or the specimen container is received in the second receptacle 106 and the strap 110 extends around and/or adjacent at least a portion of the medical device or the specimen container, the locking insert 114 engaging the shoulders 116. Accordingly, the locking insert 114 and shoulders 116 bear against each other, the shoulders 116 preventing a release of locking insert 114. The locking insert 114 in turn prevents a displacement or release of the medical device or the specimen container, for example as a result of its own weight or when an abrupt force is applied to the medical device or the specimen container.

In other embodiments, the securing structure 109 may additionally, or alternatively, include hook and loop fasteners such as VELCRO®, adhesives, snap fasteners, mechanical fasteners, self-locking mechanisms, and/or one-time use temporary adhesives including a release liner, for example to better suit sterile applications, and/or any other fastening means suitable to maintain the medical device in place for a duration of the specimen-collecting procedure.

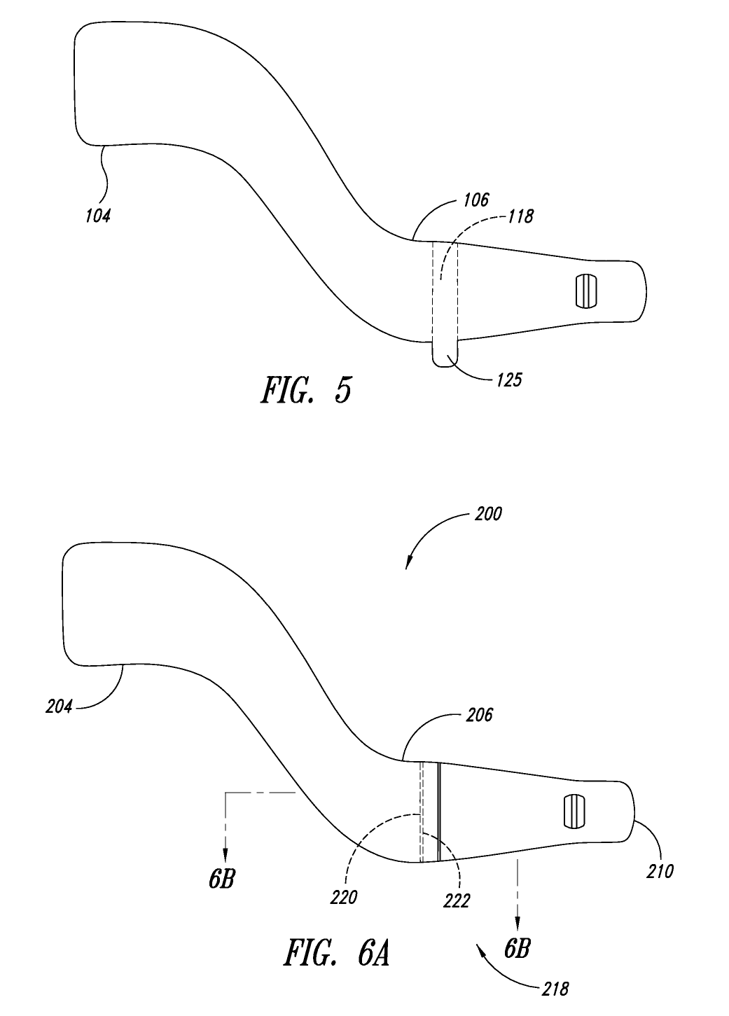

Additionally, or alternatively, the locking device 112 can include one of a hook and a loop mat that receives the other of the hook and loop mat, which can take the place of or be added to the locking insert 114 in embodiments in which the securing structure 109 includes a hook and loop fastening system. In other embodiments, as illustrated in FIG. 5, the locking device may include other structure for receiving the locking insert 114, in addition to or instead of the shoulders 116. In yet other embodiments, the securing structure 109 may include a combination of different structures, for example, hook and loop fasteners used in combination with the locking insert 114 and locking structure 112 described above.

The strap 110, locking device 112 and locking insert 114 may be fabricated from any suitable material such as nylon, silicone, natural and/or synthetic rubbers, plastics, elastics, composites, and/or any other material, that is optionally elastic, flexible and/or resilient, and adapted to firmly secure the medical device.

Furthermore, although the strap 110 is shown with one locking insert 114, the strap 110 may comprise a plurality of locking inserts 114 for adjusting a length of the strap 110 that is positioned adjacent at least the portion of the medical device or specimen container. Additionally, or alternatively, a surface of the strap 110 that forms a mating surface between the strap 110 and a surface of the second receptacle 106 adjacent the locking structure 112, after the locking structure 112 engages the locking insert 114, may include a structure, such as a plurality of grooves 128. The grooves 128 are illustrated in FIG. 3A before the locking structure 112 engages the locking insert 114 and in FIG. 3B after the locking structure 112 engages the locking insert 114. The grooves 128 are oriented to allow sliding the strap 110 through the locking structure 112 in a first direction to tighten the strap and engage the locking structure 112 to the locking insert 114 for securing the medical device in the second receptacle 106. For example, the grooves 128 may include a slanted wedge shape as illustrated in FIG. 3A.

In such an embodiment, an interaction of the grooves 128 and the surface of the second receptacle 106 can resist the strap 110 from sliding back in a second direction, opposed to the first direction, to prevent the strap 110 from inadvertently loosening due to an unexpected release of the locking insert 114 from the locking structure 112.

When desired, the user may raise the strap 110 separating the grooves 128 from the surface of the receptacle 106 and the strap 110 may slide back to loosen the strap 110 by widening the locking structure 112 and/or using a release mechanism (not shown). Additionally or alternatively, the user may laterally pull the strap 110 and twist it to slide a portion of the strap adjacent the locking insert 114 out from the locking structure 112. Although details of the securing structure according to some embodiments are described for a thorough understanding of the illustrated and other embodiments, this disclosure is not limited to the described embodiments. Other embodiments may use other fastening or securing structures without deviating from the scope of the present invention.

As shown in FIGS. 3A and 5, the device 100 may further comprise at least one separating structure 118 for separating and disposing the strap 110 after using the device 100. The separating structure 118 can be a notch or a step, forming a thickness disparity that weakens an attachment between the at least one of the first and the second receptacles 104, 106 and the strap 110. After use, the user may apply a force, such as a pulling force, to the strap 110 to detach or tear the strap 110 proximate the separating structure 118. Furthermore, as illustrated in FIG. 5, the device 100 may comprise an optional tab 125 configured to facilitate the separating of the separating structure 118 and thus of the strap 110.

In some embodiments, the body 102, the first receptacle 104, the second receptacle 106, the strap 110 and the locking structure are fabricated from a unitary body of material.

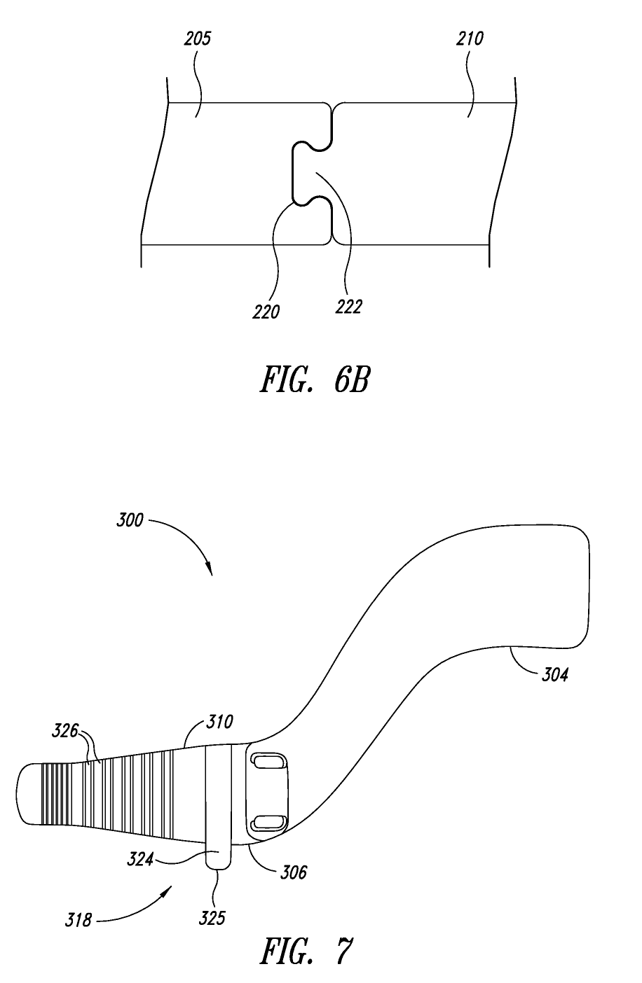

FIGS. 6A and 6B illustrate another embodiment, in which a specimen handling device 200 comprises a separating structure 218 that accommodates removal and replacement of a strap 210. For example, a recess 220, which may be at least partially cylindrical, can be formed at an open end of at least one arm 205 of the first and/or the second receptacles 204, 206. The recess 220 may comprise any shape, and extend along at least a portion of a dimension, such as a height, of the at least one arm 205. The strap 210 may in turn include an insert 222 toward an end thereof. The insert 222 is configured to slide into and out of the recess 220 of the second receptacle 206, removably securing the strap 210 to the second receptacle 206. As the insert 222 slides into the recess 220, the strap 210 is secured to the at least one arm 205. Those of skill in the art can appreciate other embodiments comprising other suitable separating structures, such as, but not limited to, hook and loop fasteners, adhesives, another securing structure, similar to that described with respect to the locking structure 112 and locking insert 114, and/or any other suitable separating structure for removing and/or replacing the strap 210.

FIG. 7 illustrates yet another embodiment, in which a separating structure 318 of a specimen handling device 300 may additionally or alternatively comprise a tear-away strap 324 that assists in separating a strap 310 from a second receptacle 306. The tear-away strap 324 may include a tab 325 to further assist in separating the tear-away strap 324 and thus the strap 310. Furthermore, the strap 310 may comprise a plurality of channel members 326 that reduce the weight and aid in the flexibility of the strap 310. A thickness of the strap 310 across the channel members 326 is less than a thickness of a remainder of the strap 310 to reduce a weight of the handling device and promote a flexibility of the strap 310.

It is understood that in other embodiments, a specimen handling device, such as the devices 100, 200, 300 described above, may comprise a securing structure for the first receptacles 104, 204, 304 similar to that discussed in conjunction with the second receptacles 106, 206, 306.

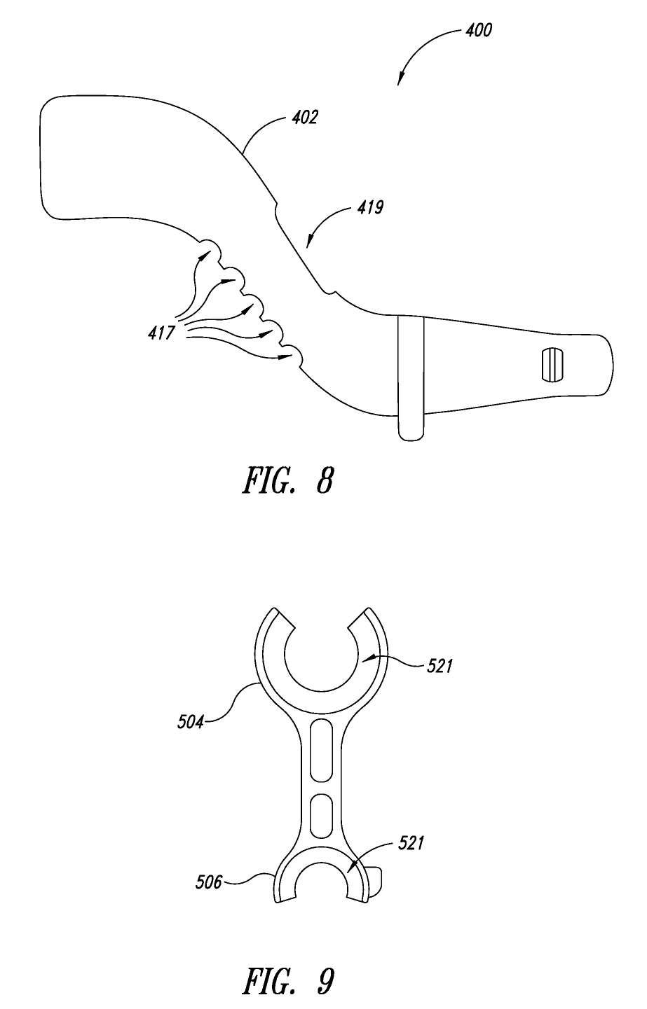

In another embodiment as illustrated in FIG. 8, a specimen handling device 400 may include a body 402 having one or more indentations 417 configured to conform to the user's grip. For example, a plurality of indentations 417 may receive the user's fingers to provide for a comfortable, ergonomic, and secure grip. In addition, or instead, the body 402 may include an elongated indentation 419 for receiving the user's palm.

In still another embodiment as illustrated in FIG. 9, a specimen handling device 500 may comprise a first receptacle 504 and a second receptacle 506, at least one of which includes a tapered, at least partially cylindrical surface 521 giving the at least one of the first and the second receptacles 504, 506 an at least partially frustoconical shape. Accordingly, devices and containers of varying sizes and/or shapes may be inserted in the at least one receptacle 504, 506 and secured in place when they reach a portion of the at least partially frustoconical receptacles 504, 506 where a diameter of the receptacles 504, 506 grips the device and/or the container.

One of skill in the art having reviewed this disclosure can appreciate these and other modifications that can be made to the specimen handling devices 100, 200, 300, 400, 500 discussed herein without deviating from the scope of the present invention.

An operation of the device 100 of FIGS. 2, 3A, and 3B is now described by way of an example, which is not intended in a limiting sense, but rather to provide an understanding of the device 100 in use and to make more apparent other uses and embodiments that may include modifications to the described embodiments without departing from the scope of the present invention.

In operation, the user grips the body 102 of the device 100 and removably secures the specimen container 132 in the first receptacle 104. Next, the user removably secures the medical device 130, such as an endoscope, in the second receptacle 106. If desired, the user may further secure the medical device 130 by fastening it in place using the strap 110 in a manner as described above. The user can now easily manipulate the medical device 130 with one hand without having to also secure the specimen container 132, which is supported by the first receptacle 104. The medical device 130 can be in fluid communication with the specimen container 132, for example via a tube made of plastic, nylon, rubber, silicone, composites, and/or any other suitable material. Therefore, as the user operates the medical device 130, the specimen can be collected in the specimen container 132. After use, the user may place the device 100 on a surface expediently without spillage or back flow concerns because the device 100 secures the medical device 130 and the specimen container 132 until the user removes them from the device 100. To remove the specimen container 132, the user may unfasten the strap 310 and manually remove the specimen container 132.

As shown in FIG. 2, the body 102 may be angled with respect to the first and second receptacles 104, 106. For example, the body 102 may be at a decline with respect to the first receptacle 104 and at an incline with respect to the second receptacle 106. An angled body 102 may provide for a more comfortable and/or ergonomic holding position and grip; however, the body 102 may alternatively extend linearly between the first and the second receptacles 104, 106. Other embodiments are possible. For example, the body 102 may include a cushioned, resilient, and/or flexible exterior.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims and equivalents thereof.

1. A handling device comprising:
a first receptacle configured to removably secure a container;
a second receptacle configured to removably secure a medical device; and
a body interposed between the first and the second receptacles and configured to allow a user to manually manipulate the handling device with one hand.

2. The handling device of claim 1 wherein the first and the second receptacles each comprise a first arm and a second arm for removably securing the container and the medical device, respectively.

3. The handling device of claim 2 wherein the first and the second arms form an at least partially cylindrical shape.

4. The handling device of claim 2, further comprising:
a strap attached to one of the first and the second arms of at least one of the first and the second receptacles, the strap having at least one locking insert and being configured to extend adjacent at least a portion of the medical device or the container; and
a locking structure positioned on the other of the first and second arms configured to engage the locking insert.

5. The handling device of claim 4, further comprising:
means for separating the strap from the one of the first and the second arms of the at least one of the first and the second receptacles.

6. The handling device of claim 5 wherein the means for separating the strap comprises at least one of a tear-away strip and a material thickness disparity between the flexible strap and the second receptacle.

7. The handling device of claim 6 wherein the means for separating the strap further comprises a tab configured to aid separation of the at least one of the tear-away strip and the material thickness disparity.

8. The handling device of claim 5 wherein the means for separating the strap comprises a recess formed toward an open end of the one of the first and the second arms and an insert formed toward an end of the strap, the insert configured to removably and slidably engage the recess for removing and replacing the strap.

9. The device of claim 4 wherein the body, the first receptacle, the second receptacle, the flexible strap and the locking structure are fabricated from a unitary body of material.

10. The device of claim 4 wherein the strap comprises at least one channel member across which a thickness of the strap is less than a thickness of a remainder of the strap to reduce a weight of the handling device and promote a flexibility of the strap.

11. The device of claim 4 wherein at least one of the first receptacle, the second receptacle, and the strap comprise a resilient material.

12. The device of claim 1 wherein the body extends at an angle with respect to the first and second receptacles.

13. The device of claim 1 wherein the body comprises at least one opening to reduce a weight of the handling device.

14. The device of claim 1 wherein the body comprises at least one indent configured to receive at least one of a finger and a palm of the one hand of the user.

15. A specimen handling device comprising:
an elongated body having a first end and a second end;
a first receptacle coupled to the first end of the elongated body and having a first arm and a second arm, the first and the second arm forming a first partially cylindrical surface configured to removably engage a specimen container;
a second receptacle coupled to the second end of the elongated body and having a first arm and a second arm, the first and the second arm forming a second partially cylindrical surface configured to removably engage a medical device;
a flexible strap coupled to the first arm of the second receptacle toward a first end of the flexible strap and having a locking insert toward an opposing second end of the flexible strap, the flexible strap being configured to extend around at least a portion of the medical device and the locking insert being positioned such that the locking insert reaches the second arm after the flexible strap extends around the at least the portion of the medical device; and
a locking structure coupled to the second arm of the second receptacle and having a first shoulder and a second shoulder, the first and the second shoulder being configured to engage the locking insert for retaining the second flexible strap around the at least the portion of the medical device.

16. The specimen handling device of claim 15 wherein the partially cylindrical surface of at least one of the first and the second receptacles further comprises a tapered portion forming an at least partially frustoconical surface.

17. The specimen handling device of claim 15 wherein the flexible strap further comprises a plurality of grooves positioned between the locking insert and the second end of the strap, the grooves configured to allow the second end to slide through the locking structure in a first direction and interact with a surface of the second arm adjacent the locking structure to resist against the flexible strap from sliding in a second direction, opposed to the first direction.

18. The specimen handling device of claim 17 wherein each of the grooves comprises a slanted wedge shape.
